(19) United States
(12) Patent Application Publication
(10) Pub. No.: US 2024/0185067 A1
(43) Pub. Date: Jun. 6, 2024

(54) DRIVING REPORT GENERATION USING A DEEP LEARNING DEVICE

(71) Applicant: Micron Technology, Inc., Boise, ID (US)

(72) Inventors: Poorna Kale, Folsom, CA (US); Saideep Tiku, Folsom, CA (US)

(21) Appl. No.: 18/521,943

(22) Filed: Nov. 28, 2023

Related U.S. Application Data
(60) Provisional application No. 63/386,258, filed on Dec. 6, 2022.

(51) Int. Cl. G06N 3/08

(52) U.S. Cl. CPC G06N 3/08

(57) ABSTRACT

Methods, systems, and devices for driving report generation using a deep learning device are described. In some cases, a vehicle may use sensor data and a deep learning device to provide a report to a driver of the vehicle. The vehicle may collect data from vehicle sensors and store a set of inputs received from the sensors in a volatile memory device. One or more processing units coupled with the memory system of the vehicle system may generate a model associated with the environment of the vehicle using the stored sensory inputs. The vehicle may identify events using the model, the sensory inputs or both. In some examples, the vehicle may employ a deep learning device to generate an event report using a machine learning model and the set of inputs.

### CROSS REFERENCE

The present Application for Patent claims priority to U.S. Patent Application No. 63/386,258 by Kale et al., entitled “DRIVING REPORT GENERATION USING A DEEP LEARNING DEVICE,” filed Dec. 6, 2022, which is assigned to the assignee hereof, and which is expressly incorporated by reference herein.

### TECHNICAL FIELD

The following relates to one or more systems for memory, including driving report generation using a deep learning device.

### BACKGROUND

Memory devices are widely used to store information in various electronic devices such as computers, user devices, wireless communication devices, cameras, digital displays, and the like. Information is stored by programming memory cells within a memory device to various states. For example, binary memory cells may be programmed to one of two supported states, often corresponding to a logic 1 or a logic 0. In some examples, a single memory cell may support more than two possible states, any one of which may be stored by the memory cell. To access information stored by a memory device, a component may read (e.g., sense, detect, retrieve, identify, determine, evaluate) the state of one or more memory cells within the memory device. To store information, a component may write (e.g., program, set, assign) one or more memory cells within the memory device to corresponding states.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), 3-dimensional cross-point memory (3D cross point), not-or (NOR) and not-and (NAND) memory devices, and others. Memory devices may be described in terms of volatile configurations or non-volatile configurations. Volatile memory cells (e.g., DRAM) may lose their programmed states over time unless they are periodically refreshed by an external power source. Non-volatile memory cells (e.g., NAND) may maintain their programmed states for extended periods of time even in the absence of an external power source.

### BRIEF DESCRIPTION OF THE DRAWINGS

FIG. 1 illustrates an example of a system that supports driving report generation using a deep learning device in accordance with examples as disclosed herein.

FIG. 2 illustrates an example of a system that supports driving report generation using a deep learning device in accordance with examples as disclosed herein.

FIG. 3 illustrates an example of a process flow that supports driving report generation using a deep learning device in accordance with examples as disclosed herein.

FIG. 4 illustrates an example of a process flow that supports driving report generation using a deep learning device in accordance with examples as disclosed herein.

FIG. 5 illustrates a block diagram of a memory device that supports driving report generation using a deep learning device in accordance with examples as disclosed herein.

FIG. 6 illustrates a flowchart showing a method or methods that support driving report generation using a deep learning device in accordance with examples as disclosed herein.

### DETAILED DESCRIPTION

Some vehicle systems may implement an advanced driver assistance system (ADAS) to collect and share information to improve travel safety (e.g., to prevent collisions). As ADAS capability and availability increase. more driver behavior data may be collected. However, current vehicles may provide limited performance information to the driver associated with trip meta data and metrics. Additional information may be useful to the driver and others. For example, a new driver may benefit from specific feedback on driving decisions and suggestions for how to improve. In other examples, vehicle insurers may desire information about driver performance (e.g., for determining insurance rates). In other examples, taxi services and fleet coordinators may utilize reports on driver performance (e.g., for ensuring accountability for their drivers). In some examples, such as in response to a collision that occurs during a trip, trip information may be used by law enforcement in documenting the collision, determining fault or both. In these and other examples, more driver and trip information may be desirable.

In some implementations, a vehicle may use sensor data and a deep learning device to provide a report to a driver of the vehicle. For example, the vehicle may collect data from vehicle sensors and store a set of inputs received from the sensors in a volatile memory device. One or more processing units coupled with the memory system of the vehicle system may generate a model associated with the environment of the vehicle using the stored sensory inputs. The vehicle may identify events (e.g., a sharp turn, a stop sign, a collision, etc.) using the model, the sensory inputs or both. In some examples, the vehicle may employ a deep learning device to generate an event report using a machine learning model and the set of inputs. The deep leaming may be integrated with a memory system of the vehicle. In some examples, the vehicle may transmit the event report to an output device and store the event report in a non-volatile memory device of the memory system. In some examples, the deep learning device may provide feedback or suggestions during the trip (e.g., while the driver is driving), for example using a head up display (HUD). The driver or other interested party may use the generated report to improve driving safety and accountability.

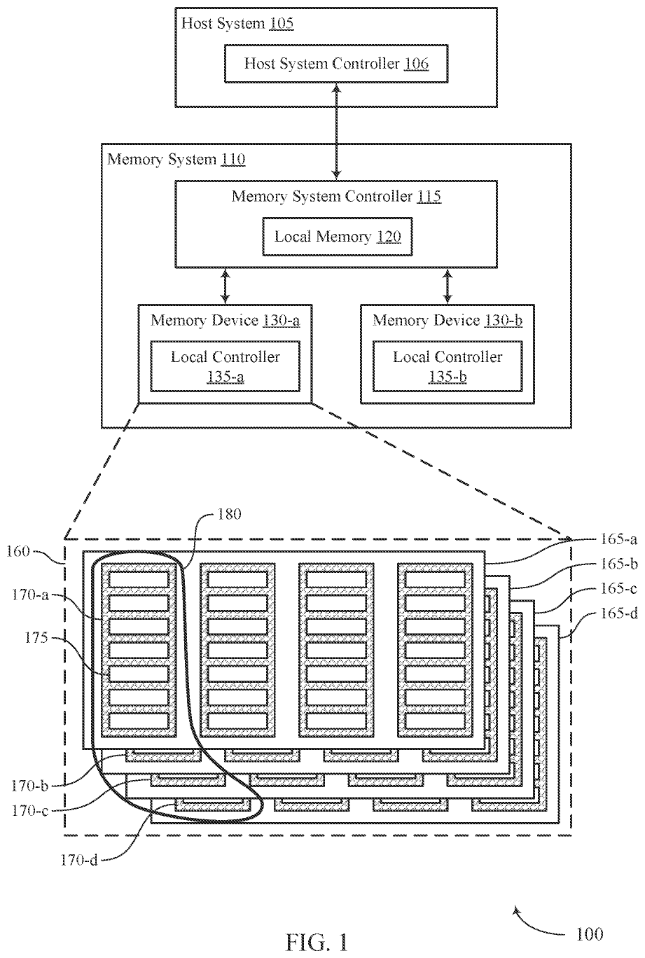

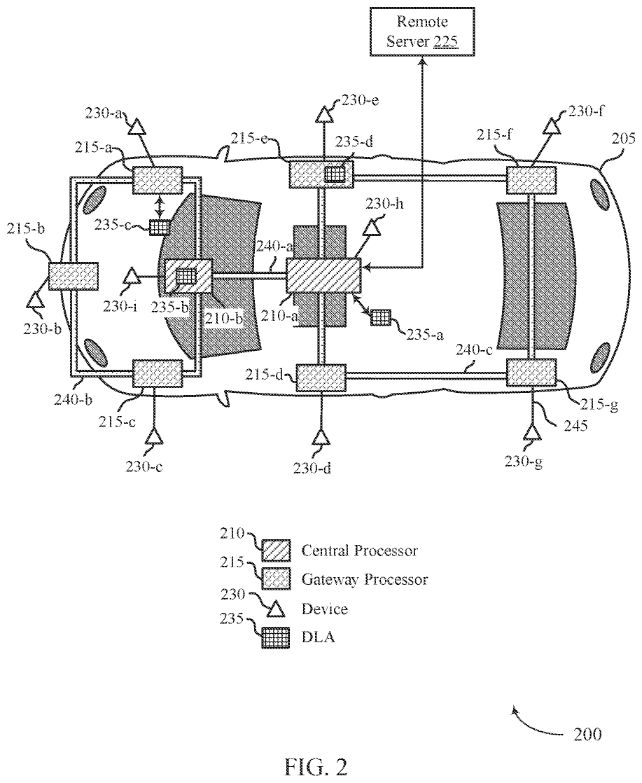

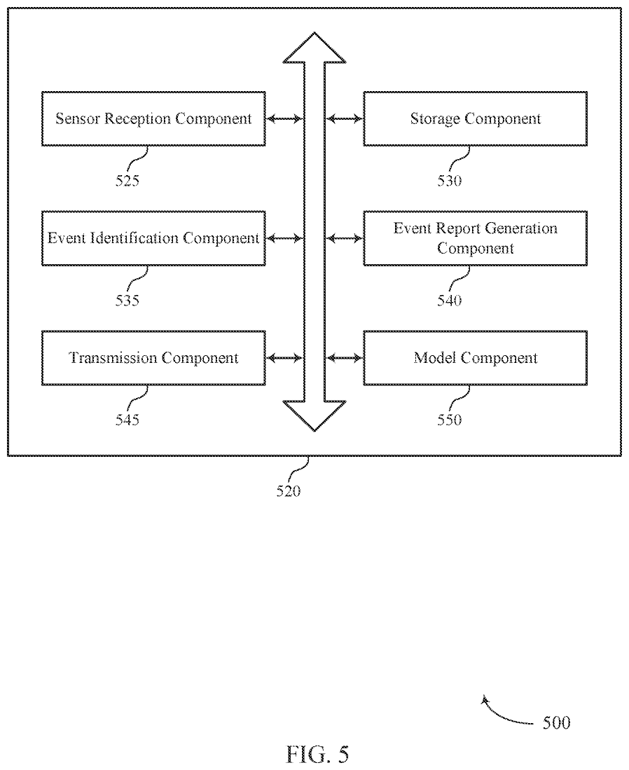

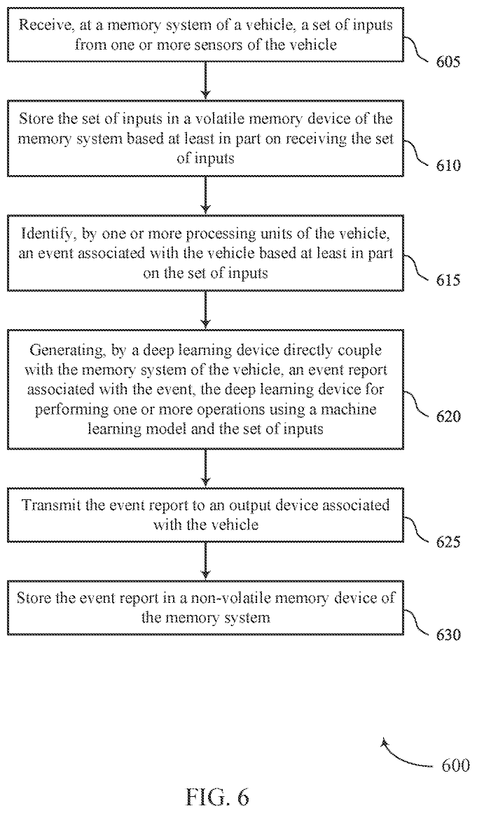

Features of the disclosure are initially described in the context of systems, devices, and circuits with reference to FIG. 1. Features of the disclosure are described in the context of a system and process flows with reference to FIGS. 2 through 4. These and other features of the disclosure are further illustrated by and described in the context of an apparatus diagram and flowchart that relate to driving report generation using a deep learning device with reference to FIGS. 5 through 6.

FIG. 1 illustrates an example of a system 100 that supports driving report generation using a deep learning device in accordance with examples as disclosed herein. The system 100 includes a host system 105 coupled with a memory system 110.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other possibilities.

The system 100 may be included in a computing device such as a desktop computer, a laptop computer, a network server, a mobile device, a vehicle (e.g., airplane, drone, train, automobile, or other conveyance), an Internet of Things (IoT) enabled device, an embedded computer (e.g., one included in a vehicle, industrial equipment, or a networked commercial device), or any other computing device that includes memory and a processing device.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (RAM) (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example. a memory device 130 may include RAM memory cells, such as dynamic RAM (DRAM) memory cells and synchronous DRAM (SDRAM) memory cells.

In some examples, a memory device 130 may include (e.g., on a same die or within a same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or altematively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170, and in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in a same page 175 may share (e.g., be coupled with) a common word line, and memory cells in a same string may share (e.g., be coupled with) a common digit line (which may altematively be referred to as a bit line).

For some NAND architectures, memory cells may be read and programmed (e.g., written) at a first level of granularity (e.g., at the page level of granularity) but may be erased at a second level of granularity (e.g., at the block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

The system 100 may include any quantity of non-transitory computer readable media that support driving report generation using a deep learning device. For example, the host system 105 (e.g., a host system controller 106), the memory system 110 (e.g., a memory system controller 115), or a memory device 130 (e.g., a local controller 135) may include or otherwise may access one or more non-transitory computer readable media storing instructions (e.g., firmware, logic, code) for performing the functions ascribed herein to the host system 105, the memory system 110, or a memory device 130. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

In some cases, a vehicle may implement the system 100, which may use sensor data and a deep learning device to provide a report to a driver of the vehicle. For example, the vehicle may collect data from vehicle sensors and store a set of inputs received from the sensors in a volatile memory device. One or more processing units coupled with the memory system of the vehicle system may generate a model associated with the environment of the vehicle using the stored sensory inputs. The vehicle may identify events (e.g., a sharp turn, a stop sign, a collision, etc.) using the model, the sensory inputs or both. In some examples, the vehicle may employ a deep learning device to generate an event report using a machine learning model and the set of inputs. In some examples, the vehicle may transmit the event report to an output device and store the event report in a non-volatile memory device of the memory system. In some examples. the deep learning device may provide feedback or suggestions during the trip (e.g., while the driver is driving), for example using a head up display (HUD). The driver or other interested party may use the generated report to improve driving safety and accountability.

FIG. 2 illustrates an example of a system 200 that supports driving report generation using a deep learning device in accordance with examples as disclosed herein. The system 200 may implement or be implemented by aspects of the system 100 described with reference to FIG. 1. For example, the system 200 may depict operation of a zonal computing system of a vehicle 205 that includes various components, such as central processors 210, gateway processors 215, memory systems, devices 230, and DLAs 235 which may be examples of corresponding devices described with reference to FIG. 1. In some cases, devices 230 may include devices such as sensors or actuators for the system 200. Additionally, the system 200 may support the utilization of machine learning processes via the DLAs 235 to enable tasks such as autonomous driving, machine vision, voice recognition, and natural language processing, among other tasks.

The vehicle 205 may implement a zonal computing system to manage various devices that may be included in the vehicle 205. For example, the vehicle 205 may include a zonal computing system in which different groups of components of the vehicle 205 are divided into various zones and managed in accordance with the zones. The zonal computing system may include one or more central processors 210 that are configured to communicate with a remote server 225. For example, the zonal computing system may include a central processor 210-a and a central processor 210-b that may each be configured to communicate with the remote server 225. In some examples, the remote server 225 may provide the vehicle 205 access to a network, and the vehicle 205 may receive data from the network via the remote server 225. In some examples, the remote server 225 may be an example of a cloud server. The central processors 210 may communicate with the remote server 225 wirelessly, for example, using one or more antennas of the vehicle 205 in accordance with one or more radio access technologies.

The central processors 210 may additionally be configured to communicate with various zones of the zonal computing system. For example, the zonal computing system may include: gateway processors 215; and devices 230, which may include actuators that are configured to control (e.g., trigger, cause, or perform actions with) a subsystem of the vehicle 205 or sensors that are configured to measure a physical property associated with the vehicle 205 or an environment associated with the vehicle 205 (e.g., a motion sensor, a camera, a radar sensor, a speedometer, a gas meter, a fuel temperature sensor, an oxygen sensor, a light detection and ranging (LIDAR) sensor, or some other sensor that may be included in the vehicle 205); among other computing components that may be included in the zonal computing system. Each of the gateway processors 215 and devices 230 may be associated with a respective zone of the zonal computing system. The gateway processors 215 may be coupled with at least one of the central processors 210 (e.g., directly or via one or more other gateway processors 215) and with one or more devices 230, or a combination thereof. Additionally, the gateway processors 215 may be configured to route communications between the at least one central processor 210 and the respective devices 230 with which the gateway processors 215 are coupled. Accordingly, the central processors 210 may be configured to communicate with devices 230 of a zone via one or more gateway processors 215 associated with the zone. In some examples, a zone may include a communication path coupled with one or more gateway processors 215.

In the example of FIG. 2, the zonal computing system may include a gateway processor 215-a, a gateway processor 215-b, a gateway processor 215-c, a gateway processor 215-d, a gateway processor 215-e, a gateway processor 215-f, and a gateway processor 215-g, although any quantity of gateway processors 215 may be included in the zonal computing system of the vehicle 205. In some examples, each gateway processor 215 may be associated with a different zone of the zonal computing system. For example, the gateway processor 215-a may be associated with a first zone of the zonal computing system, the gateway processor 215-b may be associated with a second zone of the zonal computing system, the gateway processor 215-c may be associated with a third zone of the zonal computing system, and so on. In other examples, multiple gateway processors 215 may be associated a single zone of the zonal computing system. For example, the gateway processor 215-a, the gateway processor 215-b, and the gateway processors 215-c may be associated with the first zone; the gateway processor 215-d and the gateway processor 215-e may be associated with the second zone, and the gateway processor 215-f and the gateway processor 215-g may be associated with the third zone. In some examples, the central processors 210 may be coupled with one or more devices 230. For example, the central processor 210-a may be coupled with a device 230-h, and the central processor 210-b may be coupled with a device 230-i. In some examples, the device 230-h and 230-i may be associated with different zones of the zonal computing system or with one of the zones with which the central processors 210 are configured to communicate (e.g., one of the zones associated with a gateway processor 215).

The devices 230 included in the vehicle 205 may be associated with the respective zones of the gateway processors 215 with which they are coupled. For example, in the example of FIG. 2, the gateway processor 215-a may be coupled with a device 230-a, the gateway processor 215-b may be coupled with a device 230-b, the gateway processor 215-c may be coupled with a device 230-c, the gateway processor 215-d may be coupled with a device 230-d, the gateway processor 215-e may be coupled with a device 230-e, the gateway processor 215-f may be coupled with a device 230-f, and the gateway processor 215-g may be coupled with a device 230-g. Each of the devices 230-a through 230-g may be associated with (e.g., included in) the zone with which the corresponding gateway processor 215 is associated (e.g., the first zone through a seventh zone, respectively).

The components of the zonal computing system may communicate according to various communication protocols. For example, the central processors 210 and the gateway processors 215 may be coupled over various signal buses 240 that operate according to a first communication protocol. For instance, the central processor 210-a and the central processor 210-b may communicate over a signal bus 240-a. The central processor 210-b may communicate with the gateway processor 215-a, the gateway processor 215-b, and the gateway processor 215-c over a signal bus 240-b. The central processor 210-a may communicate with the gateway processor 215-d, the gateway processor 215-e, the gateway processor 215-f, and the gateway processor 215-g over a signal bus 240-c. In some examples, the central processors 210 may communicate with the gateway processors 215 directly or indirectly over the signal buses 240. For example. the central processor 210-b may be directly coupled with the gateway processor 215-a and the gateway processor 215-c over the signal bus 240-b and indirectly coupled with the gateway processor 215-b over the signal bus 240-b via the gateway processor 215-a, the gateway processor 215-c, or both. Thus, communications between the central processor 210-b and the gateway processor 215-b may be routed through the gateway processor 215-a, the gateway processor 215-c, or both. Additionally, the central processor 210-a may be directly coupled with the gateway processor 215-d and the gateway processor 215-e over the signal bus 240-c and indirectly coupled with the gateway processor 215-f and the gateway processor 215-g over the signal bus 240-c. In some examples, the signal buses 240 may be examples of ethernet cables and the first communication protocol may be an ethernet communication protocol according to which the central processors 210 and the gateway processors 215 may communicate.

Additionally, the devices 230 may be coupled with respective gateway processors 215 or central processors 210 over various signal buses 245 that operate according to one or more different communication protocols. In some examples, the one or more different communication protocols may be lower capacity or bandwidth communication protocols with respect to the first communication protocol, such as a serial communication protocol. The gateway processors 215 may be configured to translate information between the first communication protocol (e.g., used to communicate information between the gateway processors 215 and the central processors 210) and the one or more different communication protocols (e.g., used between the gateway processors 215 and the devices 230). For example, the gateway processor 215-a may translate information that is communicated from the central processor 210-b to the device 230-a from the first communication protocol to a second communication protocol. Additionally, the gateway processor 215-a may translate information that is communicated from the device 230-a to the central processor 210-b from the second communication protocol to the first communication protocol. As such, the central processors 210 may communicate information with the devices 230 to control various operations and functions of the vehicle 205 (e.g., such as operations related to autonomous driving, alert notifications, etc.).

The zonal computing system of the vehicle 205 may include one or more DLAs 235 configured to perform operations of the components of the zonal computing system by utilizing one or more neural networks. In some cases, the use of neural networks may help to reduce power consumption and reduce latency, among other performance operations. The DLAs 235 may include machine learning processes and other advanced computing techniques that may be utilized by the components of the zonal computing system. For example, a processor of the vehicle 205 (e.g., a central processor 210, a gateway processor 215) may transmit information to a DLA 235, which the DLA 235 may use as input into one or more neural networks. The DLA 235 may transmit responsive information to the processor that is output by the one or more neural networks based on the information received from the processor. For instance, the processor may transmit information gathered from one or more devices 230 to the DLA 235, and the DLA 235 may input the information into one or more neural networks, for example, for the purposes of supporting data analytics or autonomous driving, among other operations of the vehicle 205 supported by the processor. The DLA 235 may transmit outputs of the one or neural networks to the processor, which the processor may use in performing, for example, the data analytics, autonomous driving, etc.

A DLA 235 may be included in (e.g., embedded in) or coupled with a central processor 210 or a gateway processor 215. For example, in the example of FIG. 2, the central processor 210-a may be coupled with a DLA 235-a, the central processor 210-b may include (e.g., be embedded with) a DLA 235-b, the gateway processor 215-a may be coupled with a DLA 235-c, the gateway processor 215-e may include a DLA 235-d, or a combination thereof. It is noted, however, that FIG. 2 depicts an example configuration of DLAs 235 within the vehicle 205 and that any combination of components of the zonal computing system may include or be coupled with a respective DLA 235.

A memory system may be included in (e.g., embedded in) or coupled with a central processor 210 or a gateway processor 215 and coupled with a DLA 235. For example, in the example of FIG. 2, a first memory system may be coupled with the central processor 210-a and the DLA 235-a, a second memory system may be included (e.g., embedded) in the central processor 210-b and coupled with the DLA 235-b, a third memory system may be coupled with the gateway processor 215-a and the DLA 235-c, a fourth memory system may be included in the gateway processor 215-e and coupled with the DLA 235-d, or a combination thereof. It is noted, however, that FIG. 2 depicts an example configuration of memory systems within the vehicle 205 and that any combination of components of the zonal computing system may include or be coupled with a respective memory system.

In some cases, a DLA 235 may be directly coupled with a non-volatile memory system, a volatile memory system, or both within a single package. For example, a DLA 235 may be arranged or implemented on a first die, and a volatile memory system, such as a DRAM device, may be arranged or implemented on a second die. The first die and the second die may be included in a same package, which may support a high-bandwidth connection between the DLA 235 and the volatile memory system. Accordingly, the DLA 235 may use the volatile memory system as a buffer (e.g., a cycle buffer) as part of performing machine-learning processes. Additionally or alternatively, the DLA 235 may include on-board volatile memory, such as SRAM or other memory types which may be implemented in a same die as the DLA 235. Accordingly, the DLA 235 may be included in a single die package. In such cases, the DLA 235 may use the on-board memory as a buffer (e.g., a cycle buffer) as part of performing machine-learning processes.

In some cases, the DLA 235 may directly couple with a non-volatile memory system, such as a NAND device. For example, the non-volatile memory device may be positioned above or below the DLA 235 in a vertical to support hybrid bonding between the non-volatile memory system and the DLA 235. Such bonding of the DLA 235 with the non-volatile memory system may support high-bandwidth data transmission between the DLA 235 and the non-volatile memory system.

In some cases, the system may use the devices 230 to measure or record various environmental factors or events. For example, the devices 230 may include or may be an example of cameras (e.g., rear view cameras, side view cameras) which may record one or more video streams of the environment in the vicinity of the vehicle 205, such as videos streams of the rear of the vehicle 205. Additionally, the vehicle 205 may include one or more LiDAR sensors, which may be configured to detect objects and determine a distance to the objects (e.g., a distance between the vehicle 205 and a detected object). The vehicle 205 may also include one or more radar sensors, which may be configured to detect objects, determine distances to detects objects, determine velocity of detected objects, or any combination thereof. The vehicle 205 may also include one or more sound navigation and ranging (sonar) sensors, which may be configured to use ultrasonic sound waves to detect positions of one or more objects (e.g., relative to the vehicle 205). The vehicle 205 may include one or more inertial measurement units (IMUs), which may measure and report forces experienced by the vehicle 205.

The system 200 may use video streams and, in some cases, inputs from additional sensors (e.g., speedometers, thermometers, engine monitoring sensors, weather monitoring sensors) to detect events and generate associated reports. For example, the devices 230 (e.g., cameras, LiDAR, radar, sonar, and other sensors) may provide the video streams and additional inputs to the one or more DLAs 235 or other computing platforms, such as one or more central processors 210, of the vehicle 205.

The one or more DLAs 235, one or more central processors 210, or both may process the video streams and additional inputs to identify sections of a trip (e.g., critical driving sections of a session of operating the vehicle 205) and provide a report to a driver of the vehicle 205. For example, the vehicle 205 may collect data from devices 230 and store a set of inputs received from the device 230 in a volatile memory device. One or more processing units, such as one or more central processors 210, one or more gateway processor 215, one or more DLAs 235, or a combination thereof coupled with the memory system of the vehicle 205 system may generate a model associated with the environment of the vehicle 205 using the stored sensory inputs. The vehicle 205 may identify events (e.g., a sharp turn, a stop sign, a collision, etc.) using the model, the sensory inputs or both. In some examples, the vehicle 205 may employ a deep learning device (e.g., a DLA 235) to generate an event report using a machine learning model and the set of inputs. In some examples, the vehicle 205 may transmit the event report to an output device and store the event report in a non-volatile memory device of the memory system. In some examples. the deep learning device may provide feedback or suggestions during the trip (e.g., while the driver is driving), for example using a head up display (HUD). The driver or other interested party may use the generated report to improve driving safety and accountability.

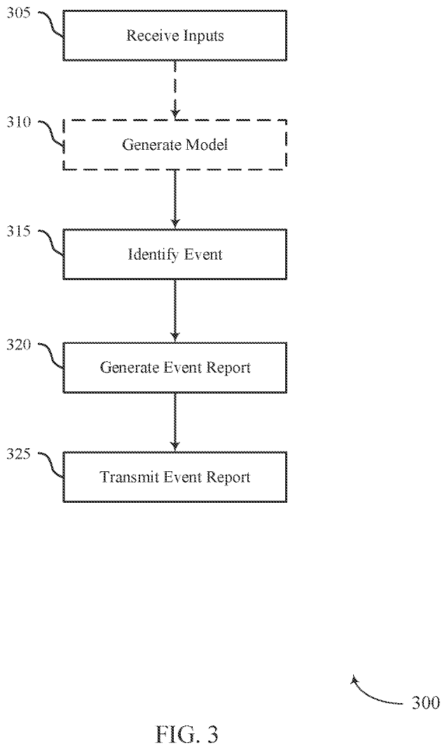

FIG. 3 illustrates an example of a process flow 300 that supports driving report generation using a deep learning device in accordance with examples as disclosed herein. The process flow 300 may implement or be implemented to realize aspects of the system 100 or the system 200. For example, aspects of a vehicle (e.g., a vehicle 205), such as one or more central processors 210, one or more gateway processors 215, one or more devices 230, one or more DLAs 235, or a combination thereof may implement the process flow 300. In the following description of process flow 300, the operations may be performed in a different order than the order shown. For example, specific operations may also be left out of process flow 300, or other operations may be added to process flow 300.

The process flow 300 may illustrate a process to generate an event report of a section of a trip of the vehicle (e.g., a critical driving section). For example, at 305, a memory system of the vehicle may receive a set of inputs from one or more sensors of the vehicle. The one or more sensors may include one or more cameras, one or more LIDAR sensors, one or more radar sensors, one or more sonar sensors, an IMU, a speedometer, an accelerometer, one or more infrared light detectors, or any combination thereof. The set of inputs may include a video stream captured by the one or more cameras, distance information associated with one or more objects included in the video stream (e.g., distances from the vehicle to other nearby vehicles), location information associated with the one or more objects, a speed of the vehicle, a respective speed of one or more of the one or more objects, an acceleration of the vehicle, infrared light information associated with an environment of the vehicle, or any combination thereof. The memory system may store the set of inputs in a memory device, such as a volatile memory device, in response to receiving the set of inputs.

At 310, one or more processing units of the vehicle (e.g., one or more central processors 210) may generate a model of the physical environment in the vicinity of the vehicle using the set of inputs. The model may include a physical representation of the vehicle with respect to the environment (e.g., a wireframe, a point-cloud, or a combination thereof). The model may also capture various forces experienced by the vehicle or passengers in the vehicle. For example, the model may use inputs from the IMU to model forces experienced by the vehicle. Generating the model may include identifying objects in the environment of the vehicle 205. For example, the one or more processing units may identify one or more second vehicles included in a video stream included in the set of inputs (e.g., using machine vision). In some examples, the one or more processing units may identify respective speeds of the one or more second vehicles using parameters, such as LiDAR information, radar information, sonar information, or a combination thereof included in the set of inputs.

At 315, the one or more processing units may identify an event associated with the vehicle using the set of inputs received by the memory system at 305, the model generated at 310, or both. In some examples, the one or more processing units may flag sections of the trip (e.g., critical driving sections of a session of operating the vehicle 205). In some cases, the event may include the vehicle transitioning between a first lane and a second lane included in a video stream (e.g., a lane change), executing a turn, or a second vehicle being within a threshold distance of the vehicle. Identifying the event may include determining, using the set of inputs, whether the vehicle is transitioning between a first lane and a second lane, whether the vehicle is executing turn, or whether a second vehicle is within a threshold distance of the vehicle. In some examples, the one or more processing units may share inputs from the set of inputs. For example, a first processing unit may transmit data from a first sensor, such as a video stream, to a second compute unit associated with a second sensor, such as a LIDAR, to associated a distance to an object detected by the LiDAR to a vehicle included in the video stream. In some examples, the one or more processing units may communicate using an optical interface, such as a photonic interconnect.

In some examples, a deep leaming device, such as a DLA 235, may generate an indication of a first action associated with the event. For example, the deep learning device may, using one or more machine learning models, determine a driving action (e.g., modify speed, change direction) using an autonomous driving model. Because such an action may correspond to an action which would be taken by the vehicle if the autonomous driving model were operating the vehicle, the action may be referred to as a recommended action. In some examples, a deep learning device may generate an indication of the recommended action associated with the event and display the recommended action on a display component of the vehicle, such as a head-up display (HUD). In some examples, the DLA 235 may be incorporated with a memory system. In such examples, the DLA 235 may analyze data as it is stored in a volatile memory device or a non-volatile memory device of the memory system. The close-coupling of the DLA 235 with the memory system may enable the DLA 235 to analyze the sensor data with greater efficiency because of reductions to path lengths the data may take.

At 320, the memory system may generate an event report associated with the event using a machine learning model and the set of inputs received by the memory system at 305. For example, the machine learning model may be one or more neural networks and the deep learning device may be or include one or more DLAs 235. In some examples. the event report may include an evaluation of a second action executed by the vehicle 205 using the indication of the first action associated with the event. For example, the memory system may compare the action taken by the vehicle with the recommended action, and determine a score based on how closely the action taken by the vehicle matches the recommended action. In some examples, the event report may include the indication of the recommended action associated with the event generated by the machine learning model, a comparison between the action taken by the vehicle and the recommended action, a comparison between the action taken by the vehicle and a similar action taken by another driver, or any combination thereof. The event report may also include video feeds from the trip (e.g., from critical driving sections of a session of operating the vehicle 205) and instructions on how the driver may improve their driving.

At 325, the memory system may transmit the event report to an output device associated with the vehicle. For example, the memory system may transmit the report to a remote server (e.g., a cloud server) associated with the vehicle. Additionally, the memory system may store the event report in a non-volatile memory device of the vehicle.

Aspects of the process flow 300 may be implemented by a controller, among other components. Additionally or alternatively, aspects of the process flow 300 may be implemented as instructions stored in memory (e.g., firmware stored in a memory coupled with the host system or the memory system). For example, the instructions, when executed by a controller, may cause the controller to perform the operations of the process flow 300.

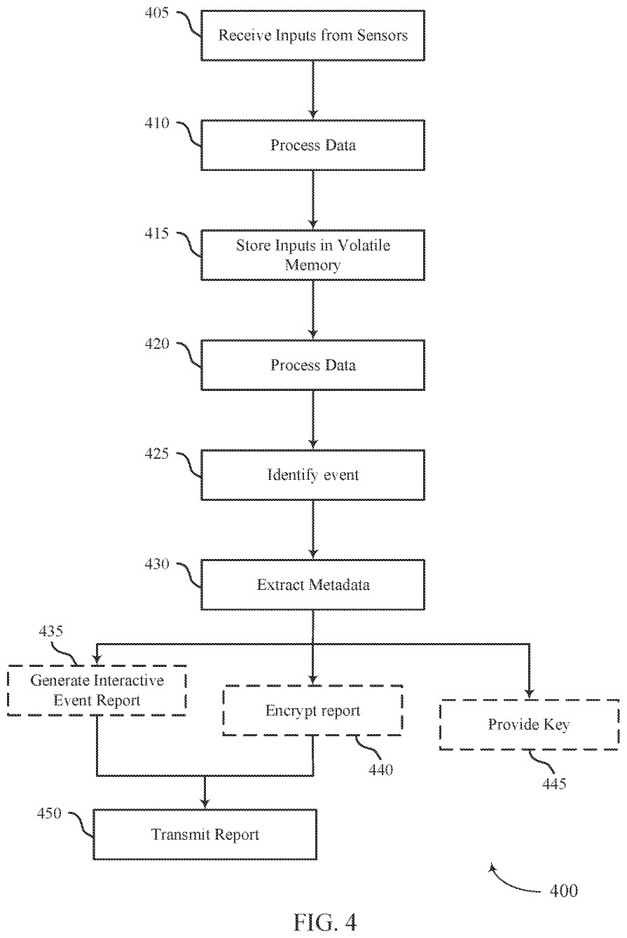

FIG. 4 illustrates an example of a process flow 400 that supports driving report generation using a deep learning device in accordance with examples as disclosed herein. The process flow 400 may implement or be implemented to realize aspects of the system 100 or the system 200. For example, aspects of a vehicle (e.g., a vehicle 205), such as one or more central processors 210, one or more gateway processors 215, one or more devices 230, one or more DLAs 235, or a combination thereof may implement the process flow 400. In the following description of process flow 400, the operations may be performed in a different order than the order shown. For example, specific operations may also be left out of process flow 400, or other operations may be added to process flow 400.

The process flow 400 may illustrate a process to generate a report of an accident associated with the vehicle (e.g., a collision) and securely store or provide the report to a driver of the vehicle or other entities, such as law enforcement, insurance companies, or both. The entities may use the report to obtain a summary of causes or other aspects of the accident. For example, at 405, a memory system of the vehicle may receive a set of inputs from one or more sensors of the vehicle. The one or more sensors may include one or more cameras, one or more light detection and ranging sensors, one or more radar sensors, one or more sonar sensors, an inertial measurement unit, a speedometer, an accelerometer, one or more infrared light detectors, or any combination thereof. The set of inputs may include a video stream, distance information associated with one or more objects included in the video stream, location information associated with the one or more objects, a speed of the vehicle, a respective speed of one or more of the one or more objects, an acceleration of the vehicle, infrared light information associated with an environment of the vehicle. or any combination thereof.

The memory system may, at 410 process the input data to generate a model of the physical environment in the vicinity of the vehicle. The model may include a physical representation of the vehicle with respect to the environment (e.g., a wireframe, a point-cloud, or a combination thereof). The model may also capture various forces experienced by the vehicle or passengers in the vehicle. For example, the model may use inputs from the IMU to model forces experienced by the vehicle. Generating the model may include identifying objects in the environment of the vehicle 205. For example, the one or more processing units may identify one or more second vehicles included in a video stream included in the set of inputs (e.g., using machine vision). In some examples, the one or more processing units may identify respective speeds of the one or more second vehicles using parameters, such as LiDAR information, radar information, sonar information, or a combination thereof included in the set of inputs. In some examples, the memory system may process the data prior to storing the inputs in a non-volatile memory device at 415 (e.g., may process the data stored in a volatile memory device, such as a large-cycle buffer).

Additionally or alternatively, the memory system may process the data after storing the inputs in a non-volatile memory device. For example, at 420, hardware accelerators may compress the data for uploading to a cloud service via a dedicated high-speed internet connection. Compressed data uploaded to a cloud service may allow users to access data in cases where the vehicle sustains severe damage (e.g., in a severe accident).

At 425, the one or more processing units may identify an event associated with the vehicle using the set of inputs, the model generated at 410, the model generated at 420, or a combination thereof. For example, the one or more processing units may identify a collision or a near-collision with another vehicle. In some cases, identifying the collision may include determining whether a second vehicle is within a threshold distance of the vehicle. In some examples, the one or more processing units may share inputs from the set of inputs. For example, a first processing unit may transmit data from a first sensor, such as a video stream, to a second compute unit associated with a second sensor, such as a LiDAR, to associated a distance to an object detected by the LiDAR to a vehicle included in the video stream. In some examples, the one or more processing units may communicate using an optical interface, such as a photonic interconnect.

At 430, the memory system may identify and extract metadata associated with the event. For example, the memory system may identify: a speed of the vehicle; speeds of other nearby vehicles; forces experienced by the vehicle (e.g., using and IMU); environmental conditions (e.g., weather conditions, road conditions); or a combination thereof. In some examples, the memory system may generate a report that may include the extracted metadata.

At 435, the memory system may generate an interactive event report. For example, the memory system may use the model generated at 410, at 420, or both to create a visual, three-dimensional representation of the event (e.g., a representation of the vehicle and the environment surrounding the vehicle). The interactive event report may allow a user to examine a physical representation of the event from one or more angles or from one or more magnifications.

At 440, the one or more processing units may encrypt the report generated at 435, for example using one or more encryption keys. At 445, the one or more processing units may provide an encryption key of the one or more encryption keys, to the user. For example, the encryption key may be a secure password shared with the user. In some examples, the interactive event report generated at 435 may also be encrypted. The one or more reports may include the metadata extracted at 430.

At 450, the one or more reports (e.g., the interactive report, the encrypted report, or both) may be transmitted to the user. For example, the one or more reports may be transmitted over a mobile or web app. In some examples, the one or more reports may be optionally shared to a secure cloud server or other remote server associated with the vehicle In some examples, the one or more reports may be transmitted and stored without user intervention such that authorities may be granted access to unaltered or untampered data (e.g., in the event of an accident).

Aspects of the process flow 400 may be implemented by a controller, among other components. Additionally or alternatively, aspects of the process flow 400 may be implemented as instructions stored in memory (e.g., firmware stored in a memory coupled with the host system or the memory system). For example, the instructions, when executed by a controller, may cause the controller to perform the operations of the process flow 400.

FIG. 5 illustrates a block diagram 500 of a memory device 520 that supports driving report generation using a deep learning device in accordance with examples as disclosed herein. The memory device 520 may be an example of aspects of a memory device as described with reference to FIGS. 1 through 4. The memory device 520, or various components thereof, may be an example of means for performing various aspects of driving report generation using a deep learning device as described herein. For example, the memory device 520 may include a sensor reception component 525, a storage component 530, an event identification component 535, an event report generation component 540, a transmission component 545, a model component 550, or any combination thereof. Each of these components may communicate, directly or indirectly, with one another (e.g., via one or more buses).

The sensor reception component 525 may be configured as or otherwise support a means for receiving, at a memory system of a vehicle, a set of inputs from one or more sensors of the vehicle. The storage component 530 may be configured as or otherwise support a means for storing the set of inputs in a volatile memory device of the memory system based at least in part on receiving the set of inputs. The event identification component 535 may be configured as or otherwise support a means for identifying, by one or more processing units of the vehicle, an event associated with the vehicle based at least in part on the set of inputs. The event report generation component 540 may be configured as or otherwise support a means for generating, by a deep learning device directly coupled with the memory system of the vehicle, an event report associated with the event, the deep learning device for performing one or more operations using a machine leaming model and the set of inputs. The transmission component 545 may be configured as or otherwise support a means for transmitting the event report to an output device associated with the vehicle. In some examples, the storage component 530 may be configured as or otherwise support a means for storing the event report in a non-volatile memory device of the memory system.

In some examples, the model component 550 may be configured as or otherwise support a means for generating, by the one or more processing units, a model associated with an environment of the vehicle using the set of inputs, where identifying the event is further based at least in part on the model.

In some examples, the event report generation component 540 may be configured as or otherwise support a means for generating, by the deep learning device, an indication of a first action associated with the event. In some examples, the event report generation component 540 may be configured as or otherwise support a means for determining an evaluation of a second action executed by the vehicle based at least in part on the indication of the first action, where the event report includes the evaluation.

In some examples, the event report generation component 540 may be configured as or otherwise support a means for generating, by the machine learning model, an indication of a recommended action associated with the event. In some examples, the transmission component 545 may be configured as or otherwise support a means for transmitting the indication of the recommended action to a display component of the vehicle.

In some examples, to support generating the model, the sensor reception component 525 may be configured as or otherwise support a means for identifying one or more second vehicles included in a video stream, the video stream included in the set of inputs. In some examples, to support generating the model, the sensor reception component 525 may be configured as or otherwise support a means for identifying respective speeds of the one or more second vehicles using one or more parameters included in the set of inputs.

In some examples, the model component 550 may be configured as or otherwise support a means for identifying metadata of a model associated with an environment of the vehicle based at least in part on identifying the event. In some examples, the transmission component 545 may be configured as or otherwise support a means for transmitting the metadata to a remote server associated with the vehicle.

In some examples, the model component 550 may be configured as or otherwise support a means for encrypting the metadata using the one or more processing units, where transmitting the metadata includes transmitting the encrypted metadata to the remote server.

In some examples, to support identifying the event, the sensor reception component 525 may be configured as or otherwise support a means for determining, based at least in part on the set of inputs, whether a second vehicle is within a threshold distance of the vehicle.

In some examples, to support identifying the event, the sensor reception component 525 may be configured as or otherwise support a means for determining, based at least in part on the set of inputs, whether the vehicle is transitioning between a first lane and a second lane included in a video stream of the set of inputs.

In some examples, to support identifying the event, the sensor reception component 525 may be configured as or otherwise support a means for determining, based at least in part on the set of inputs, whether the vehicle is executing a turn.

In some examples, the transmission component 545 may be configured as or otherwise support a means for transmitting the event report to a remote server associated with the vehicle.

In some examples, the transmission component 545 may be configured as or otherwise support a means for transmitting data associated with the set of inputs from a first processing unit of the one or more processing units to a second processing unit of the one or more processing units using an optical interconnect between the first processing unit and the second processing unit, where identifying the event is based at least in part on transmitting the data.

In some examples, the one or more sensors include one or more cameras, one or more light detection and ranging sensors, one or more radar sensors, one or more sonar sensors, an inertial measurement unit, a speedometer, an accelerometer, one or more infrared light detectors, or a combination thereof, and the set of inputs include a video stream, distance information associated with one or more objects included in the video stream, location information associated with the one or more objects, a speed of the vehicle, a respective speed of one or more of the one or more objects, an acceleration of the vehicle, infrared light information associated with an environment of the vehicle, or a combination thereof.

FIG. 6 illustrates a flowchart showing a method 600 that supports driving report generation using a deep learning device in accordance with examples as disclosed herein. The operations of method 600 may be implemented by a memory device or its components as described herein. For example, the operations of method 600 may be performed by a memory device as described with reference to FIGS. 1 through 5. In some examples, a memory device may execute a set of instructions to control the functional elements of the device to perform the described functions. Additionally, or alternatively, the memory device may perform aspects of the described functions using special-purpose hardware.

At 605, the method may include receiving, at a memory system of a vehicle, a set of inputs from one or more sensors of the vehicle. The operations of 605 may be performed in accordance with examples as disclosed herein. In some examples, aspects of the operations of 605 may be performed by a sensor reception component 525 as described with reference to FIG. 5.

At 610, the method may include storing the set of inputs in a volatile memory device of the memory system based at least in part on receiving the set of inputs. The operations of 610 may be performed in accordance with examples as disclosed herein. In some examples, aspects of the operations of 610 may be performed by a storage component 530 as described with reference to FIG. 5.

At 615, the method may include identifying. by one or more processing units of the vehicle, an event associated with the vehicle based at least in part on the set of inputs. The operations of 615 may be performed in accordance with examples as disclosed herein. In some examples, aspects of the operations of 615 may be performed by an event identification component 535 as described with reference to FIG. 5.

At 620, the method may include generating, by a deep learning device directly coupled with the memory system of the vehicle, an event report associated with the event, the deep learning device for performing one or more operations using a machine leaming model and the set of inputs. The operations of 620 may be performed in accordance with examples as disclosed herein. In some examples, aspects of the operations of 620 may be performed by an event report generation component 540 as described with reference to FIG. 5.

At 625, the method may include transmitting the event report to an output device associated with the vehicle. The operations of 625 may be performed in accordance with examples as disclosed herein. In some examples, aspects of the operations of 625 may be performed by a transmission component 545 as described with reference to FIG. 5.

At 630, the method may include storing the event report in a non-volatile memory device of the memory system. The operations of 630 may be performed in accordance with examples as disclosed herein. In some examples, aspects of the operations of 630 may be performed by a storage component 530 as described with reference to FIG. 5.

In some examples, an apparatus as described herein may perform a method or methods, such as the method 600. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving, at a memory system of a vehicle, a set of inputs from one or more sensors of the vehicle; storing the set of inputs in a volatile memory device of the memory system based at least in part on receiving the set of inputs; identifying, by one or more processing units of the vehicle, an event associated with the vehicle based at least in part on the set of inputs; generating, by a deep learning device directly coupled with the memory system of the vehicle, an event report associated with the event, the deep learning device for performing one or more operations using a machine leaming model and the set of inputs; transmitting the event report to an output device associated with the vehicle; and storing the event report in a non-volatile memory device of the memory system.

Aspect 2: The method, apparatus, or non-transitory computer-readable medium of aspect 1, further including operations, features, circuitry, logic, means, or instructions, or any combination thereof for generating, by the one or more processing units, a model associated with an environment of the vehicle using the set of inputs, where identifying the event is further based at least in part on the model.

Aspect 3: The method, apparatus, or non-transitory computer-readable medium of aspect 2, further including operations, features, circuitry, logic, means, or instructions, or any combination thereof for generating, by the deep learning device, an indication of a first action associated with the event and determining an evaluation of a second action executed by the vehicle based at least in part on the indication of the first action, where the event report includes the evaluation.

Aspect 4: The method, apparatus, or non-transitory computer-readable medium of any of aspects 2 through 3, further including operations, features, circuitry, logic, means, or instructions, or any combination thereof for generating, by the machine learning model, an indication of a recommended action associated with the event and transmitting the indication of the recommended action to a display component of the vehicle.

Aspect 5: The method, apparatus, or non-transitory computer-readable medium of any of aspects 2 through 4, where generating the model includes operations, features, circuitry, logic, means, or instructions, or any combination thereof for identifying one or more second vehicles included in a video stream, the video stream included in the set of inputs and identifying respective speeds of the one or more second vehicles using one or more parameters included in the set of inputs.

Aspect 6: The method, apparatus, or non-transitory computer-readable medium of any of aspects 1 through 5, further including operations, features, circuitry, logic, means, or instructions, or any combination thereof for identifying metadata of a model associated with an environment of the vehicle based at least in part on identifying the event and transmitting the metadata to a remote server associated with the vehicle.

Aspect 7: The method, apparatus, or non-transitory computer-readable medium of aspect 6, further including operations, features, circuitry, logic, means, or instructions, or any combination thereof for encrypting the metadata using the one or more processing units, where transmitting the metadata includes transmitting the encrypted metadata to the remote server.

Aspect 8: The method, apparatus, or non-transitory computer-readable medium of any of aspects 1 through 7, where identifying the event includes operations, features, circuitry, logic, means, or instructions, or any combination thereof for determining, based at least in part on the set of inputs, whether a second vehicle is within a threshold distance of the vehicle.

Aspect 9: The method, apparatus, or non-transitory computer-readable medium of any of aspects 1 through 8, where identifying the event includes operations, features, circuitry, logic, means, or instructions, or any combination thereof for determining, based at least in part on the set of inputs, whether the vehicle is transitioning between a first lane and a second lane included in a video stream of the set of inputs.

Aspect 10: The method, apparatus, or non-transitory computer-readable medium of any of aspects 1 through 9, where identifying the event includes operations, features, circuitry, logic, means, or instructions, or any combination thereof for determining, based at least in part on the set of inputs, whether the vehicle is executing a turn.

Aspect 11: The method, apparatus, or non-transitory computer-readable medium of any of aspects 1 through 10, further including operations. features, circuitry, logic, means, or instructions, or any combination thereof for transmitting the event report to a remote server associated with the vehicle.

Aspect 12: The method, apparatus, or non-transitory computer-readable medium of any of aspects 1 through 11, further including operations, features, circuitry, logic, means, or instructions, or any combination thereof for transmitting data associated with the set of inputs from a first processing unit of the one or more processing units to a second processing unit of the one or more processing units using an optical interconnect between the first processing unit and the second processing unit, where identifying the event is based at least in part on transmitting the data.

Aspect 13: The method, apparatus, or non-transitory computer-readable medium of any of aspects 1 through 12, where the one or more sensors include one or more cameras, one or more light detection and ranging sensors, one or more radar sensors, one or more sonar sensors, an inertial measurement unit, a speedometer, an accelerometer, one or more infrared light detectors, or a combination thereof, and the set of inputs include a video stream, distance information associated with one or more objects included in the video stream, location information associated with the one or more objects, a speed of the vehicle, a respective speed of one or more of the one or more objects, an acceleration of the vehicle, infrared light information associated with an environment of the vehicle, or a combination thereof.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” refers to a condition of moving from an open-circuit relationship between components in which signals are not presently capable of being communicated between the components over a conductive path to a closed-circuit relationship between components in which signals are capable of being communicated between components over the conductive path. If a component. such as a controller, couples other components together, the component initiates a change that allows signals to flow between the other components over a conductive path that previously did not permit signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed and second condition or action may at least partially occur as a result of the previous condition or action occurring (whether directly after or after one or more other intermediate conditions or actions occurring after the first condition or action).

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processor, firmware, or any combination thereof. If implemented in software executed by a processor, the functions may be stored on or transmitted over, as one or more instructions or code, a computer-readable medium. Other examples and implementations are within the scope of the disclosure and appended claims. For example, due to the nature of software, the described functions can be implemented using software executed by a processor, hardware, firmware, hardwiring, or combinations of any of these. Features implementing functions may also be physically located at various positions, including being distributed such that portions of functions are implemented at different physical locations.

For example, the various illustrative blocks and components described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the altemative, the processor may be any processor, controller, microcontroller, or state machine. A processor may be implemented as a combination of computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk, and Blu-ray disc, where disks usually reproduce data magnetically, while discs reproduce data optically with lasers. Combinations of these are also included within the scope of computer-readable media.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method, comprising:
receiving, at a memory system of a vehicle, a set of inputs from one or more sensors of the vehicle;
storing the set of inputs in a volatile memory device of the memory system based at least in part on receiving the set of inputs;
identifying, by one or more processing units of the vehicle, an event associated with the vehicle based at least in part on the set of inputs;
generating, by a deep leaming device directly coupled with the memory system of the vehicle, an event report associated with the event, the deep learning device for performing one or more operations using a machine learning model and the set of inputs;
transmitting the event report to an output device associated with the vehicle; and
storing the event report in a non-volatile memory device of the memory system.

2. The method of claim 1, further comprising:
generating, by the one or more processing units, a model associated with an environment of the vehicle using the set of inputs, wherein identifying the event is further based at least in part on the model.

3. The method of claim 2, further comprising:
generating, by the deep learning device, an indication of a first action associated with the event; and
determining an evaluation of a second action executed by the vehicle based at least in part on the indication of the first action, wherein the event report comprises the evaluation.

4. The method of claim 2, further comprising:
generating, by the machine learning model, an indication of a recommended action associated with the event; and
transmitting the indication of the recommended action to a display component of the vehicle.

5. The method of claim 2, wherein generating the model comprises:
identifying one or more second vehicles included in a video stream, the video stream included in the set of inputs; and
identifying respective speeds of the one or more second vehicles using one or more parameters included in the set of inputs.

6. The method of claim 1, further comprising:
identifying metadata of a model associated with an environment of the vehicle based at least in part on identifying the event; and
transmitting the metadata to a remote server associated with the vehicle.

7. The method of claim 6, further comprising:
encrypting the metadata using the one or more processing units, wherein transmitting the metadata comprises transmitting the encrypted metadata to the remote server.

8. The method of claim 1, wherein identifying the event comprises:
determining, based at least in part on the set of inputs, whether a second vehicle is within a threshold distance of the vehicle.

9. The method of claim 1, wherein identifying the event comprises:
determining, based at least in part on the set of inputs, whether the vehicle is transitioning between a first lane and a second lane included in a video stream of the set of inputs.

10. The method of claim 1, wherein identifying the event comprises:
determining, based at least in part on the set of inputs, whether the vehicle is executing a turn.

11. The method of claim 1, further comprising:
transmitting the event report to a remote server associated with the vehicle.

12. The method of claim 1, further comprising:
transmitting data associated with the set of inputs from a first processing unit of the one or more processing units to a second processing unit of the one or more processing units using an optical interconnect between the first processing unit and the second processing unit, wherein identifying the event is based at least in part on transmitting the data.

13. The method of claim 1, wherein the one or more sensors comprise one or more cameras, one or more light detection and ranging sensors, one or more radar sensors, one or more sonar sensors, an inertial measurement unit, a speedometer, an accelerometer, one or more infrared light detectors, or a combination thereof, and the set of inputs comprise a video stream, distance information associated with one or more objects included in the video stream, location information associated with the one or more objects, a speed of the vehicle, a respective speed of one or more of the one or more objects, an acceleration of the vehicle, infrared light information associated with an environment of the vehicle, or a combination thereof.

14. A non-transitory computer-readable medium storing code, the code comprising instructions executable by a processor to:
receive, at a memory system of a vehicle, a set of inputs from one or more sensors of the vehicle;
store the set of inputs in a volatile memory device of the memory system based at least in part on receiving the set of inputs;
identify, by one or more processing units of the vehicle, an event associated with the vehicle based at least in part on the set of inputs;
generating, by a deep leaming device directly couple with the memory system of the vehicle, an event report associated with the event, the deep learning device for performing one or more operations using a machine learning model and the set of inputs;
transmit the event report to an output device associated with the vehicle; and
store the event report in a non-volatile memory device of the memory system.

15. The non-transitory computer-readable medium of claim 14, wherein the instructions are further executable by the processor to:
generating, by the one or more process units, a model associated with an environment of the vehicle using the set of inputs, wherein identifying the event is further based at least in part on the model.

16. The non-transitory computer-readable medium of claim 15, wherein the instructions are further executable by the processor to:
generating, by the deep learning device, an indication of a first action associate with the event; and
determine an evaluation of a second action executed by the vehicle based at least in part on the indication of the first action, wherein the event report comprises the evaluation.

17. The non-transitory computer-readable medium of claim 15, wherein the instructions are further executable by the processor to:
generating, by the machine learning model, an indication of a recommended action associated with the event; and
transmit the indication of the recommended action to a display component of the vehicle.

18. The non-transitory computer-readable medium of claim 15, wherein the instructions to generate the model are executable by the processor to:
identify one or more second vehicles included in a video stream, the video stream included in the set of inputs; and
identify respective speeds of the one or more second vehicles using one or more parameters included in the set of inputs.

19. The non-transitory computer-readable medium of claim 14, wherein the instructions are further executable by the processor to:
identify metadata of a model associated with an environment of the vehicle based at least in part on identifying the event; and
transmit the metadata to a remote server associated with the vehicle.

20. An apparatus, comprising:
a controller associated with a memory device, wherein the controller is configured to cause the apparatus to:
receive, at a memory system of a vehicle, a set of inputs from one or more sensors of the vehicle;
store the set of inputs in a volatile memory device of the memory system based at least in part on receiving the set of inputs;
identify, by one or more processing units of the vehicle, an event associated with the vehicle based at least in part on the set of inputs;
generating, by a deep learning device directly couple with the memory system of the vehicle, an event report associated with the event, the deep learning device for performing one or more operations using a machine learning model and the set of inputs;
transmit the event report to an output device associated with the vehicle; and
store the event report in a non-volatile memory device of the memory system.
